(19) United States
(12) Patent Application Publication
(10) Pub. No.: US 2003/0026934 A1
(43) Pub. Date: Feb. 6, 2003

(54) Decorative elements and kit for pumpkins

(75) Inventor: Erin Elise Damon, Minneapolis, MN (US)

Correspondence Address: MERCHANT & GOULD PC, P.O. BOX 2903, MINNEAPOLIS, MN, 55402-0903, US

(73) Assignee: Hanover Accessories, Inc.

(21) Appl. No.: 10/068,151

(22) Filed: Feb. 6, 2002

Related U.S. Application Data
(60) Provisional application No. 60/279,371, filed on Mar. 28, 2001.

(51) Int. Cl. G09F 3/00

(52) U.S. Cl. 428/43; 428/100; 446/100

(57) ABSTRACT

A decorative element for use on a pumpkin or other like object, for example, a gourd, is provided which includes a decorative body and a fastening device capable of being attached to the pumpkin or other like body. The decorative body further includes an attachment surface and the fastening device further includes an attachment area. The attachment area is capable receiving the attachment surface.

### PRIORITY

This application claims priority to provisional application, entitled, DECORATIVE ELEMENTS AND KIT FOR PUMPKINS, Serial No. 60/279,371, filed Mar. 28, 2001.

### FIELD OF THE INVENTION

The present invention relates to decorative elements that can be used to create a facial or other arrangement on a pumpkin or a like base. More particularly, the invention relates to decorative elements for attaching on a pumpkin or like base.

### BACKGROUND OF THE INVENTION

Generally, pumpkins are decorated to celebrate the Halloween holiday. Over the years, the tradition has grown to include decorating other objects in addition to pumpkins, for example, gourds and squash. The display of decorated pumpkins is part of the tradition and fun of Halloween. Originally, pumpkins were decorated by cleaning out the soft pulp on the inside, and carving openings representing at least eyes, nose, and mouth.

The traditional method of decorating a pumpkin is a messy process involving the inconvenience of cleaning out the pumpkin seeds and the soft pulp and allowing for individualizing of the face. This method allows little margin for error, for example, changing of the position of carved features after they are made. For example, if an eye or mouth is placed at a location that is undesirable, it cannot be changed in position. Thus, kits are available which allow for placement and rearrangement of the facial elements, such as one example shown in U.S. Pat. No. 5,091,833. Kits have also evolved to include other decorative elements such as hats, jewelry, and other fanciful objects. The elements can also be attached to the pumpkin by a pin or other device that pierces the pumpkin.

A limitation of the existing decorative elements for decorating pumpkins or other like objects is that insertion and removal of the decorative elements can be difficult. Also, once the surface of a pumpkin is pierced, either by elements or carving, it begins to decompose. Thus, there exists a need for decorative elements that are easily attached, while reducing the likelihood that a decorative body will separate from the pumpkin when the pumpkin is displayed, especially if it is displayed outdoors, where it is subject to wind forces or other elements, which can cause the decorative elements to separate from the pumpkin. There also exists the need to accomplish this without piercing the pumpkin, since seasonal displays are shown for even longer periods of time each successive season.

### SUMMARY OF THE INVENTION

A decorative element for a pumpkin or other like body comprising a decorative body and a fastening device capable of being attached to the pumpkin or other like body. The decorative body further includes an attachment surface and the fastening device further includes an attachment area. The attachment area is capable of receiving the attachment surface.

### BRIEF DESCRIPTION OF THE DRAWING

FIG. 1 is a perspective view of one example of a preferred embodiment of the present invention.

FIG. 2 is a perspective view of the example embodiment of FIG. 1 of the present invention.

### DETAILED DESCRIPTION OF THE PREFERRED EMBODIMENTS

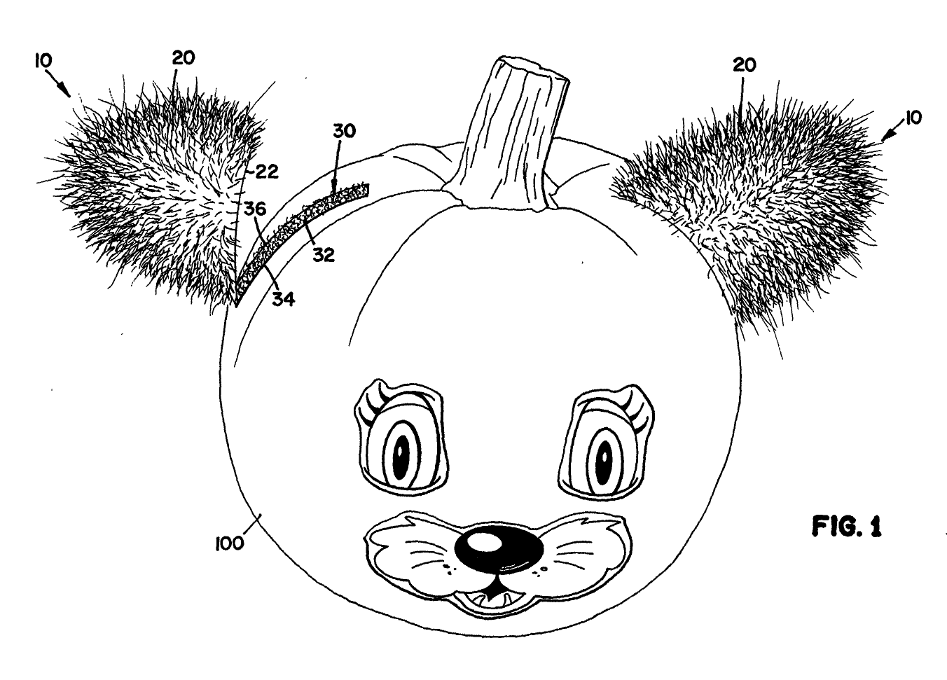

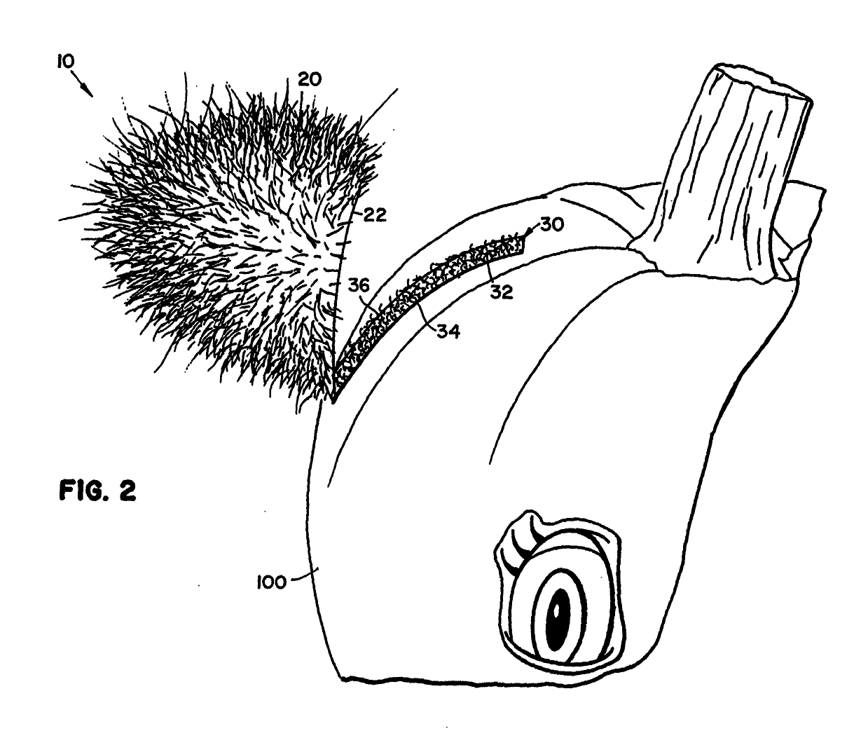

Referring to FIGS. 1 and 2, one example of a decorative element 10 of a preferred embodiment the present invention is shown. Decorative element 10 is attached to a pumpkin 100. The decorative element further includes a decorative body 20 and a fastening device 30.

Decorative body 20 can be fabricated in any shape for which it is desirable to use to decorate a pumpkin 100. In the embodiment shown in FIGS. 1 and 2, decorative body 20 is in the shape of an ear. However, decorative body 20 can take on a multitude of various shapes used in decorating pumpkin 100. Shapes commonly used include, for example, ears, eyes, hats, noses, hair, mouths, or other elements which are used to present an appearance or overall look for pumpkin 100. Decorative body 20 is preferably made from natural or synthetic materials or a combination thereof. Natural materials include, for example, cotton or wool. Synthetic materials include, for example, polyester, polyethylene, or any other material suitable for fabricating decorative bodies. One skilled in the art will recognize that the material used for decorative body 20 will vary depending on various factors, including cost, manufacturability and durability.

Fastening device 30 preferably has a first side 34 and a second side 36. First side 34 of fastening device 30 is attached to pumpkin 100 in a location suitable for attaching decorative element 10 to pumpkin 100. In the example embodiment shown in FIGS. 1 and 2, fastening device 30 is attached to pumpkin 100 in a location so that when decorative body 20 is attached to pumpkin 100, it gives the overall appearance of pumpkin 100 having an ear on each side.

First side 34 of fastening device 30 preferably includes means for securing fastening device 30 to pumpkin 100. In one embodiment, first side 34 of fastening device 30 is covered with an adhesive or glue which will suitably bond fastening device 30 to pumpkin 100. One advantage shown of the example embodiment of the present invention is that fastening device 30 is attached to pumpkin 100 without breaching the surface of the pumpkin 100 since once the pumpkin 100 is breached, for example, by penetrating it with a pin, pumpkin 100 begins to decompose. Fastening device 30 of the example embodiment, shown in FIGS. 1 and 2, does not breach the surface of pumpkin 100; therefore the decomposition process does not begin as rapidly as if the surface of pumpkin 100 was breached. Pumpkin 100 can be displayed with one or more decorative elements 10 for a longer period of time than a pumpkin decorated by carving or attaching decorations using devices that pierce pumpkin 100.

Second side 36 of fastening device 30 includes an attachment area 32. Attachment area 32 is capable of receiving an attachment surface 22 located on a portion of decorative body 20. In the example embodiment shown, attachment area 32 and attachment surface 22 are opposed mating surfaces of a hook and loop-type of attachment means. One example of a hook and loop-type attachment means is found in U.S. Pat. No. 3,943,981, sold as Velcro®. However, it will be recognized that there are many attachment means which may be employed to secure decorative body 20 to fastening device 30. Another example of attachment means would be coating attachment surface 22 and attachment area 32 with contact adhesives which allow decorative body 20 to be attached to fastening device 30. In another embodiment, decorative body 20 could be fabricated with attachment surface 22 integrated directly into the material of decorative body 20. It will be recognized by one of skill in the art that a multitude of attachment means may be employed to join attachment surface 22 to attachment area 32. In the example embodiment shown in FIGS. 1 and 2, use of hook and loop-type attachment means at attachment surface 22 and attachment area 32 allow decorative body 20 to be removably attached to the fastening device 30. An advantage of this example embodiment is that, after it is desired to no longer display pumpkin 100 with one or more decorative elements 10, decorative body 20 can be removed from fastening device 30 and stored for future use. Each decorative body 20 can be attached to a different pumpkin 100 by securing fastening device 30 to pumpkin 100 during the next display season.

Attachment surface 22 and attachment area 32 can be fabricated such that decorative body 20 is permanently secured to fastening device 30. Alternatively, attachment surface 22 can be removably secured to attachment area 32. Selection of either alternative can be dictated by cost considerations, display conditions or various other factors.

Fastening device 30 can be provided in a variety of forms. In one example embodiment, fastening device 30 is a roll-shaped strip of hook and loop-type fastener. Preferably, there are score areas at regular intervals along fastening device 30 such that a discrete length can be removed from the longer strip. In another embodiment, fastening device 30 can be separated at an area of weakness in the strip. Also, a kit can be provided that contains all the components necessary to decorate a pumpkin 100 with a variety of shapes and forms of one or more decorative element 20.

It is noted that the example embodiment shown in FIGS. 1 and 2 is for illustration purposes only. Many combinations of one or more decorative bodies 20 can be displayed on pumpkin 100. One advantage of the present invention is that a user can have a kit including one or more decorative bodies 20, each decorative body being in any of a possibility of shapes. By suitable selection of a combination of fastening device 30 and decorative body 20, one or more decorative elements can be used to decorate pumpkin 100, thereby giving it an overall theme or appearance which is limited only by the whimsy of the user.

What is claimed is:

1. A decorative element for a pumpkin comprising:
a decorative body having an attachment surface; and
a fastening device capable of being secured to the pumpkin and including an attachment area; the attachment area capable of receiving the attachment surface.

2. The decorative element of claim 1, wherein the attachment area is capable of removably receiving the attachment surface.

3. The decorative element of claim 1, wherein the attachment surface and the attachment area further comprise opposite mating portions.

4. The decorative element of claim 2, wherein the mating portions are hook and loop.

5. The decorative element of claim 2, wherein the mating portions are a releasable adhesive.

6. The decorative element of claim 1, wherein the decorative body is selected from a group comprising an ear, a hat, an eye, a nose, a hair piece and a mouth.

7. A decorative element for a pumpkin having a surface area comprising:
a decorative body;
a fastening device capable of being secured to the surface area on the pumpkin; and
means for attaching the decorative body to the fastening device.

8. The decorative element of claim 7, wherein the attachment means is capable of releasably attaching the decorative body to the fastening device.

9. The decorative element of claim 8, wherein the decorative body is selected from a group comprising an ear, a hat, an eye, a nose, a hair piece and a mouth.

10. A kit for decorating a pumpkin, the kit comprising:
a first decorative body having a first attachment surface:
a second decorative body having a second attachment surface; and
a plurality of fastening devices, each fastening device capable of being secured to the pumpkin and including an attachment area, the attachment area capable of receiving the first or second attachment surface from one of the decorative bodies.

11. The kit of claim 10, wherein the plurality of fastening devices are stored in a single roll having a separation region.

12. The kit of claim 11, wherein the separation region is a score region.

13. A decorative element for a pumpkin comprising:
a decorative body having an ornamental portion and a first mating surface;
a fastening device having first and second sides;
the first side capable of being secured to a surface of the pumpkin;
the second side having a second mating surface capable of being attached to the first mating surface.

14. The decorative element of claim 13, wherein the fastening device is hook and loop.

15. The decorative element of claim 13, wherein the first mating surface includes a releasable adhesive.

16. The decorative element of claim 13, wherein the second mating surface includes a releasable adhesive.

17. The decorative element of claim 13, wherein the first side of the fastening device includes an adhesive.
